(19) United States
(12) Patent Application Publication
(10) Pub. No.: US 2025/0132721 A1
(43) Pub. Date: Apr. 24, 2025

(54) 360 degree rotating sun panel that automatically cleans dust and resists hurricanes

(71) Applicant: Yongyang Qiu, Chino Hills, CA (US)

(72) Inventor: Yongyang Qiu, Chino Hills, CA (US)

(21) Appl. No.: 18/383,193

(22) Filed: Oct. 24, 2023

(51) Int. Cl. H02S 40/10; H02S 10/40; H02S 20/30

(52) U.S. Cl. CPC H02S 40/10; H02S 10/40; H02S 20/30

(57) ABSTRACT

The utility model relates to the field of solar energy technology and provides an outdoor rotatable solar system, comprising: a base plate, further comprising: a scissor lifting mechanism fixedly installed on the top of the base plate, and a top plate fixedly installed on the top of the scissor lifting mechanism. The utility model lifts the solar panel to a suitable height by controlling the scissor lifting mechanism, then extends it by starting the cylinder to apply a thrust to the U-shaped block, so that the mounting plate can rotate under the cooperation of the hinge, maintaining a certain tilt angle. Then, by starting the motor, the output shaft drives the circular shaft to rotate, thereby driving the mounting bracket to rotate, enabling the solar panel to face the direction of sunlight and adjust with the changing angle of sunlight, thus allowing the solar panel to receive direct sunlight for a long time and improve the efficiency of converting solar energy into electrical energy.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### SUMMARY

The present utility model can raise the solar panel to a suitable height by controlling the scissor lifting mechanism, and then extend the cylinders to exert a pushing force on the U-shaped block, so that the mounting plate can rotate under the cooperation of the hinge and maintain a certain tilt angle. Then, the motor is started to drive the circular shaft to rotate, thereby driving the mounting bracket to rotate and orient the solar panel towards the direction of sunlight and change with the angle of sunlight. This can ensure that the solar panel receives direct sunlight for a long time and improve the efficiency of solar energy conversion into electricity.

When the spherical camera detects a large amount of dust on the surface of the solar panel, the cylinders can be retracted by starting them, exerting a downward pulling force on the U-shaped block, causing the mounting plate to rotate downward under the cooperation of the hinge, reducing the angle between the mounting bracket and the mounting plate, and exerting a pushing force on the round rod by the connecting rod, which can drive the sliding block to slide to one side inside the U-shaped frame, synchronously moving the brush plate to one side and sweeping the dust on the surface of the solar panel. By connecting one end of the connecting pipe to the air pump outlet, gas can be delivered to the connecting pipe through the air pump and then sprayed out through the air nozzles after passing through the annular pipe, dispersing the dust swept by the brush plate. This repetitive process can clean the dust on the surface of the solar panel and ensure its normal use.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of the structure of an outdoor rotatable solar system provided by this utility model.

FIG. 2 is a side view of the structure of the outdoor rotatable solar system provided by this utility model.

FIG. 3 is a schematic diagram of the installation plate structure of the outdoor rotatable solar system provided by this utility model.

FIG. 4 is a schematic diagram of the structure of the U-shaped block of the outdoor rotatable solar system provided by this utility model.

FIG. 5 is a schematic diagram of the structure of the L-shaped frame of the outdoor rotatable solar system provided by this utility model.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

A rotatable outdoor solar system comprises a base plate (1) and a scissor lifting mechanism (104) fixedly installed on the top of the base plate (1). A top plate (105) is fixedly installed on the top of the scissor lifting mechanism (104) A circular shaft (201) is movably embedded at the center of the top plate (105), and a motor (202) is fixedly installed at the center of the bottom of the top plate (105). The output end of the motor (202) is fixedly installed at one end of the circular shaft (201). A mounting bracket (2) is fixedly installed at the other end of the circular shaft (201), and a mounting plate (203) is movably connected to the top of the mounting bracket (2) through a hinge. A solar panel (206) is fixedly installed at the top of the mounting plate (203). Two U-shaped blocks (204) are symmetrically fixedly installed at the bottom of the mounting plate (203), and cylinders (205) are movably embedded on the opposite sides of the two arms of the mounting plate (203).

Two U-shaped blocks are symmetrically fixedly installed at the bottom of the mounting plate, and two cylinders are movably embedded on the opposite sides of the two arms of the mounting plate.

Preferably, two support rods are symmetrically fixedly installed on one side of the mounting bracket, and connecting rods are movably sleeved on one side of the two support rods. A U-shaped frame is fixedly installed on the top of the mounting plate, and sliding blocks are slidably connected to the inner wall of the U-shaped frame. Round rods are fixedly installed on the opposite sides of the sliding blocks, and one end of the two round rods is movably embedded in one end of the two connecting rods. A brush plate is fixedly installed on the bottom of the sliding blocks.

Preferably, an annular pipe is fixedly installed on the top of the mounting plate, and multiple air nozzles are symmetrically fixedly embedded on the outer surface of the annular pipe. A connecting pipe is fixedly embedded on the outer surface of the annular pipe, connecting the connecting pipe, the annular pipe, and the multiple air nozzles.

Preferably, two L-shaped brackets are symmetrically fixedly installed on the opposite side of the bottom plate, and multiple turning rods are movably embedded on the opposite side of the two arms of the L-shaped brackets near the top. L-shaped limit plates are fixedly sleeved on the outer surface of the multiple turning rods, and torsion springs are movably sleeved on the outer surface of the multiple turning rods near both ends. One end of the multiple torsion springs is fixedly installed on the opposite side of the multiple L-shaped brackets near the top, and the other end of the multiple torsion springs is fixedly installed on both ends of the multiple turning rods. Two U-shaped blocks are symmetrically fixedly installed on the opposite side of the top plate, and rollers are movably embedded on the opposite side of the two arms of the multiple U-shaped blocks.

Preferably, positioning rings are fixedly installed at the four corners of the bottom of the top plate, and positioning rods are fixedly installed at the four corners of the top of the bottom plate.

Preferably, two brackets are symmetrically fixedly installed on the opposite side of the bottom plate, and inserting rods are movably embedded at one end of the top of the multiple brackets. Universal self-locking wheels are fixedly installed at the four corners of the bottom of the bottom plate.

Preferably, a support plate is fixedly installed on one side of the U-shaped frame, and a spherical camera is fixedly installed on one side of the support plate.

In this utility model, when encountering strong winds, the installation plate is first brought closer to the installation frame by the contraction of the cylinder, keeping the installation plate and solar panels in a horizontal position. Then, the folding mechanism is controlled to lower the height of the solar panels and insert the positioning rod into the positioning ring to provide a certain level of fixation. Simultaneously, the rollers make contact with the L-shaped limit plate and apply downward pressure, causing the L-shaped limit plate to rotate the lever, twisting the torsion spring. This rotation causes the long edge of the L-shaped limit plate to rotate downward and fit snugly against the surface of the solar panels, limiting their movement. This reduces the wind resistance on the solar panels and prevents them from becoming loose or falling off, thereby improving their lifespan.

### Legend:

1: Base plate;
101: Universal locking wheel;
102: Bracket;
103: Insert rod;
104: Folding mechanism;
105: Top plate;
106: Positioning ring;
107: Positioning rod;
2: Installation frame;
201: Circular shaft;
202: Motor;
203: Installation plate;
204: U-shaped block 1;
205: Cylinder;
206: Solar panel;
3: Support rod;
301: Connecting rod;
302: U-shaped frame;
303: Support plate;
304: Spherical camera;
305: Slider;
306: Circular rod;
307: Brush plate;
4: Connecting pipe;
401: Ring pipe;
402: Air nozzle;
5: L-shaped frame;
501: Rotating lever;
502: L-shaped limit plate;
503: Torsion spring;
6: U-shaped block 2;
601: Roller.

### Specific Implementation:

In order to better understand the purpose, features, and advantages of this utility model, the following description is provided in combination with the drawings and embodiments. It should be noted that, unless conflicting, the features in the embodiments of this application can be combined with each other.

In the following description, many specific details are provided to fully understand this utility model. However, this utility model can also be implemented in other ways not described here. Therefore, this utility model is not limited to the specific embodiments disclosed in this specification.

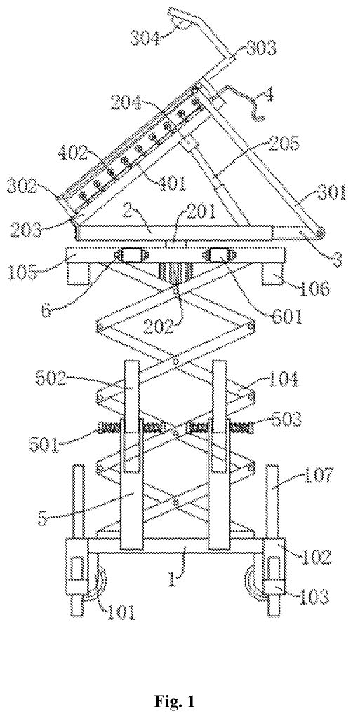

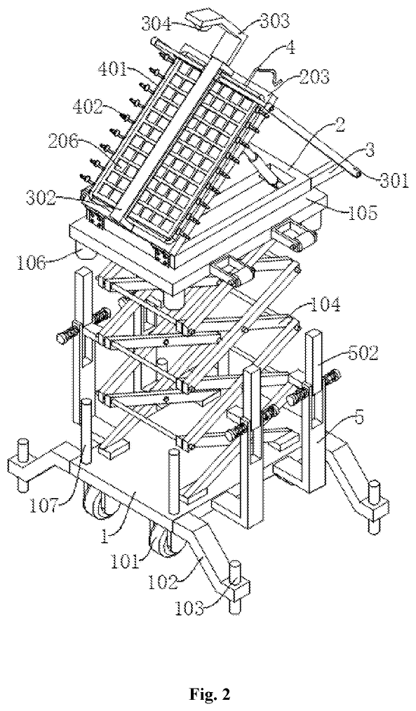

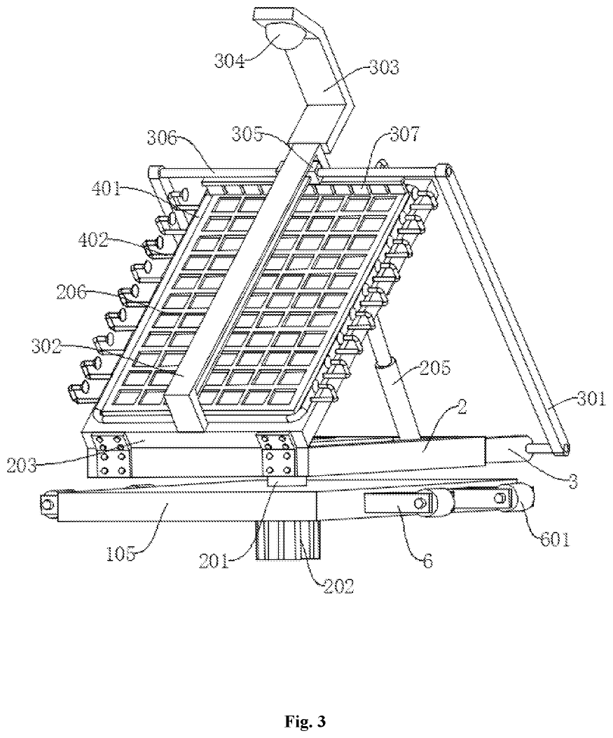

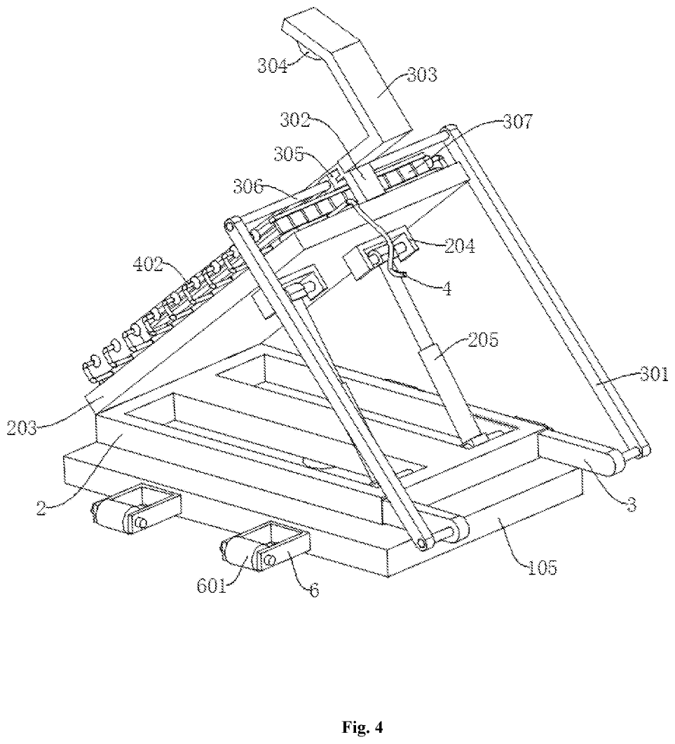

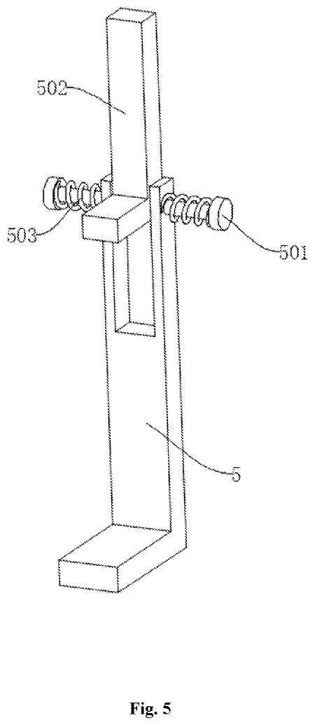

Embodiment 1, as shown in FIGS. 1-5, this utility model provides an outdoor rotatable solar system, including: a base plate 1, and further includes:

A folding mechanism 104, fixedly installed at the top of the base plate 1, with a top plate 105 fixedly installed at the top of the folding mechanism 104;

A circular shaft 201, movably embedded in the center of the top plate 105, with a motor 202 fixedly installed at the bottom center of the top plate 105. The output end of the motor 202 is fixedly installed at one end of the circular shaft 201, and the other end of the circular shaft 201 is fixedly installed with an installation frame 2. The top of the installation frame 2 is hinged to an installation plate 203. The top of the installation plate 203 is fixedly installed with a solar panel 206;

Two 19-shaped blocks 1 204, symmetrically fixedly installed at the bottom of the installation plate 203, with a cylinder 205 movably embedded on the opposite sides of the two arms of the installation plate 203, with one end of the two cylinders 205 symmetrically movably embedded on the opposite side of the inner wall of the installation frame 2.

Furthermore, as shown in FIGS. 1-5, two support rods 3 are symmetrically fixedly installed on one side of the installation frame 2, with connecting rods 301 movably sleeved on one side of the two support rods 3. The top of the installation plate 203 is fixedly installed with a U-shaped frame 302, and the inner wall of the U-shaped frame 302 is slidably connected to a slider 305. The opposite side of the slider 305 is fixedly installed with circular rods 306. One end of the two circular rods 306 is movably embedded in one end of the two connecting rods 301, and the bottom of the slider 305 is fixedly installed with brush plates 307 By applying a thrust.

Furthermore, as shown in FIGS. 1-5, the top of the installation board 203 is fixed with a circular pipe 401. Multiple air nozzles 402 are symmetrically embedded on the outer surface of the circular pipe 401. The outer surface of the circular pipe 401 is also fixed with a connecting pipe 4, which connects the connecting pipe 4, the circular pipe 401, and the multiple air nozzles 402. By connecting one end of the connecting pipe 4 to the air outlet of the air pump, gas is delivered to the connecting pipe 4 and then passes through the circular pipe 401 before being sprayed out through the air nozzles 402, dispersing the dust swept by the brush plate 307.

Furthermore, as shown in FIGS. 1-5, two L-shaped brackets 5 are symmetrically fixed on the opposite side of the bottom plate 1. Multiple rotating rods 501 are movably embedded on the side opposite to the two arms of the top of each L-shaped bracket 5. L-shaped limit plates 502 are fixedly fitted on the outer surface of each rotating rod 501. Twisting springs 503 are movably fitted on the outer surface of each rotating rod 501 near the two ends. One end of each twisting spring 503 is fixedly installed on the opposite side of each L-shaped bracket 5 near the top, while the other end of each twisting spring 503 is fixedly installed on both ends of each rotating rod 501. Two U-shaped blocks 6 are symmetrically fixed on the opposite side of the top plate 105. Each arm of the two U-shaped blocks 6 is movably embedded with a roller 601. By making the roller 601 contact the L-shaped limit plate 502 and applying downward pressure on the L-shaped limit plate 502, the L-shaped limit plate 502 can drive the rotating rod 501 to rotate, causing the twisting spring 503 to twist. This allows the long side of the L-shaped limit plate 502 to rotate downward and fit perfectly on the surface of the solar panel 206, providing positioning for the top of the solar panel 206.

Furthermore, as shown in FIGS. 1-5, positioning rings 106 are fixedly installed at the four corners of the bottom of the top plate 105, and positioning rods 107 are fixedly installed at the four corners of the top of the bottom plate 1. By inserting the positioning rods 107 into the positioning rings 106, a certain degree of fixation is achieved.

Furthermore, as shown in FIGS. 1-5, two brackets 102 are symmetrically fixed on the opposite side of the bottom plate 1. The top end of each bracket 102 is movably embedded with an insertion rod 103. Universal self-locking wheels 101 are fixedly installed at the four corners of the bottom of the bottom plate 1. By inserting the insertion rods 103 into the soil, a certain degree of fixation is achieved.

Furthermore, as shown in FIGS. 1-5, a support plate 303 is fixedly installed on one side of the U-shaped bracket 302, and a spherical camera 304 is fixedly installed on one side of the support plate 303. The spherical camera 304 is used to monitor surrounding fires, wind forces, snow disasters, heavy rains, and theft.

Operation Principle: When in use, this device is moved to the designated outdoor location by using the universal self-locking wheels 101. The wheels are then locked, and the insertion rods 103 are inserted into the soil to secure the device. The scissor lifting mechanism 104 is then controlled to lift the solar panel 206 to the appropriate height. The cylinder 205 is activated to extend and apply thrust to the U-shaped block 204, causing the installation board 203 to rotate with the hinge, maintaining a certain tilt angle. The motor 202 is then started, driving the circular shaft 201, which in turn rotates the mounting bracket 2. This allows the solar panel 206 to face the direction of sunlight and adjust its angle according to the changing sunlight angle, ensuring it receives direct sunlight for an extended period of time, thereby increasing the efficiency of solar energy conversion. When the spherical camera 304 detects a significant amount of dust on the surface of the solar panel 206, the cylinder 205 is activated to retract, applying downward tension to the U-shaped block 204. This causes the installation board 203 to rotate downward with the hinge, reducing the angle between the installation bracket 2 and the installation board 203. This applies thrust to the connecting rod 301, causing the slider 305 to slide inside the U-shaped bracket 302 and simultaneously moving the brush plate 307 to sweep the dust off the surface of the solar panel 206. By connecting one end of the connecting pipe 4 to the air outlet of the air pump, gas is delivered to the connecting pipe 4, passes through the circular pipe 401, and is then sprayed out through the air nozzles 402, dispersing the dust swept by the brush plate 307. This process is repeated to clean the surface of the solar panel 206 and ensure its normal use. In the case of strong winds, the installation board 203 is first retracted towards the installation bracket 2 by contracting the cylinder 205, keeping it and the solar panel 206 in a horizontal position. The scissor lifting mechanism 104 is then controlled to lower the height of the solar panel 206. The positioning rods 107 are inserted into the positioning rings 106 for additional fixation. The roller 601 is brought into contact with the L-shaped limit plate 502 and applies downward pressure, causing the L-shaped limit plate 502 to rotate the rotating rod 501. This twists the torsion spring 503, causing the long side of the L-shaped limit plate 502 to rotate downward and perfectly fit on the surface of the solar panel 206, providing positioning and preventing strong winds from blowing the solar panel 206. This reduces wind resistance and prevents loosening or falling of the solar panel 206, thereby extending its lifespan.

The above description is only the preferred embodiment of the present utility model and is not intended to limit the utility model to any other form. Any person skilled in the art may make changes or modifications based on the disclosed technical content to achieve equivalent embodiments in other fields. However, any simple modifications, equivalent changes, or variations made to the above embodiments, which do not depart from the technical essence of the utility model, are still within the scope of protection of the utility model.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An outdoor rotatable solar system, comprising:
a base plate (1), characterized in that it further comprises: a scissor lifting mechanism (104) fixedly installed on the top of the base plate (1), and a top plate (105) fixedly installed on the top of the scissor lifting mechanism (104);
a circular shaft (201), movably embedded at the center of the top plate (105), a motor (202) fixedly installed at the center of the bottom of the top plate (105), the output end of the motor (202) fixedly installed at one end of the circular shaft (201), a mounting bracket (2) fixedly installed at the other end of the circular shaft (201), a mounting plate (203) movably connected to the top of the mounting bracket (2) through a hinge, and a solar panel (206) fixedly installed at the top of the mounting plate (203);
two U-shaped blocks (204), symmetrically fixedly installed at the bottom of the mounting plate (203), and cylinders (205) movably embedded on the opposite sides of the two arms of the mounting plate (203).

2. An outdoor rotatable solar system according to claim 1, characterized in that:
two support rods (3) are symmetrically fixedly installed on one side of the mounting bracket (2), connecting rods (301) are movably sleeved on one side of the two support rods (3), a U-shaped bracket (302) is fixedly installed at the top of the mounting plate (203), sliders (305) are slidably connected to the inner wall of the U-shaped bracket (302), and circular rods (306) are fixedly installed on the opposite side of the sliders (305), with one end of each of the two circular rods (306) movably embedded in one end of the two connecting rods (301), and brush plates (307) are fixedly installed at the bottom of the sliders (305).

3. An outdoor rotatable solar system according to claim 2, characterized in that:
an annular pipe (401) is fixedly installed at the top of the mounting plate (203), multiple air nozzles (402) are symmetrically fixedly embedded on the outer surface of the annular pipe (401), and a connecting pipe (4) is fixedly embedded between the connecting pipe (4), the annular pipe (401), and the multiple air nozzles (402).

4. An outdoor rotatable solar system according to claim 1, characterized in that:
two L-shaped brackets (5) are symmetrically fixedly installed on the opposite side of the base plate (1), multiple turning rods (501) are movably sleeved on one side of the two arms of the L-shaped brackets (5), L-shaped limiting plates (502) are fixedly sleeved on the outer surface of the multiple turning rods (501), and torsion springs (503) are movably sleeved on the outer surface of the multiple turning rods (501) near both ends, with one end of each of the torsion springs (503) fixedly installed on the opposite side of the multiple L-shaped brackets (5) near the top, and the other end of each of the torsion springs (503) fixedly installed on both ends of the multiple turning rods (501), two U-shaped blocks (6) are symmetrically fixedly installed on the opposite side of the top plate (105), and rollers (601) are movably embedded on one side of the two arms of the U-shaped blocks (6).

5. An outdoor rotatable solar system according to claim 4, characterized in that:
positioning rings (106) are fixedly installed at the four corners of the bottom of the top plate (105), and positioning rods (107) are fixedly installed at the four corners of the top of the base plate (1).

6. An outdoor rotatable solar system according to claim 5, characterized in that:
two brackets (102) are symmetrically fixedly installed on the opposite side of the base plate (1), insertion rods (103) are movably sleeved on one end of the top of the two brackets (102), and universal self-locking wheels (101) are fixedly installed at the four corners of the bottom of the base plate (1).

7. An outdoor rotatable solar system according to claim 2, characterized in that:
a support plate (303) is fixedly installed on one side of the U-shaped bracket (302), and a spherical camera (304) is fixedly installed on one side of the support plate (303).
